(19) United States
(12) Patent Application Publication
(10) Pub. No.: US 2026/0324820 A1
(43) Pub. Date: Oct. 22, 2026

(54) SMART CANE ASSEMBLY

(71) Applicants: JENNIFER HENDRIX, WAXAHACHIE, TX (US); TYLER WILLIAM HARRIST, FORT WORTH, TX (US); KEVIN TUNG, MANSFIELD, TX (US)

(72) Inventors: JENNIFER HENDRIX, WAXAHACHIE, TX (US); TYLER WILLIAM HARRIST, FORT WORTH, TX (US); KEVIN TUNG, MANSFIELD, TX (US)

(21) Appl. No.: 19/466,395

(22) Filed: Jan. 31, 2026

Related U.S. Application Data
(63) Continuation-in-part of application No. 17/694,178, filed on Mar. 14, 2022, now abandoned.
(63) Continuation-in-part of application No. 17/893,045, filed on Aug. 22, 2022, now abandoned.
(60) Provisional application No. 63/160,249, filed on Mar. 12, 2021.
(60) Provisional application No. 63/235,621, filed on Aug. 20, 2021.

(51) Int. Cl. A45B 3/08; G01C 21/20; H04W 4/38

(52) U.S. Cl. CPC A45B 3/08; H04W 4/38; G01C 21/20

(57) ABSTRACT

A smart cane assembly includes a cane, an electronic device, and a headset. Each part is configured to communicate with the other through known wired and/or wireless communications. Data may be transmitted between them in real time to provide accurate and meaningful information to the user related to providing a 3D audible sound through the headset relating to an object in the environment. In general, the cane includes one or more sensors to detect obstacles in the environment, the electronic device processes the information, and the headset conveys the information to the user.

### CROSS REFERENCE TO RELATED APPLICATIONS

This application is a Continuation-in-Part of and claims the benefit of and right of priority to U.S. Nonprovisional Utility application Ser. No. 17/694,178, filed 14 Mar. 2022, which claims priority to U.S. Provisional Application No. 63/160,249, filed 12 Mar. 2021; and to U.S. Nonprovisional Utility application Ser. No. 17/893,045, filed 22 Aug. 2022, which claims priority to U.S. Provisional Application No. 63/235,621, filed 20 Aug. 2021, the contents of which is incorporated by reference herein in its entirety.

### BACKGROUND OF THE INVENTION

### 1. Field of the Invention

The present application relates to an electronic vision aid for visually impaired individuals, and more particularly to an assembly of electronic devices configured to assist visually impaired individuals navigate and understand their surroundings via audible representations of the environment.

### 2. Description of Related Art

The CDC reports that there are more than 285 million people who are blind or visually impaired. More than 7 million people go blind each year in the United States. The World Health Organization (WHO) states that every 5 seconds a person in the world goes blind. Every 1 minute, one of those people is a child. The loss of one's ability to move through the world has the greatest negative impact on human development. Blindness can arise from one of many different causes, such as macular degeneration, accident or injury, diabetes, and so on. Blindness works to severely limit one's ability to be mobile. This lack of mobility inherently results often in the seclusion, depression, and inability of those individuals from engaging in the public environment.

Various methods or devices have been developed to assist blind individuals in navigating and engaging in the public environment. For example, seeing-eye dogs are used to help direct an individual. Although dogs help in terms of general navigation, the dog is unable to provide accurate and detailed navigation to the blind. Additional disadvantages to the use of trained dogs to solve navigation issues is that the training of dogs can be very time consuming and costly. Additionally, distractions may arise which may get in the way of the dog performing despite training.

Another method or device is the elongated stick. The blind individual is tasked with repetitively passing the stick in a sideways motion in front of them to alert them to any obstacles. This stick only provides immediate obstacle detection but provides no additional benefit with respect to the extended environment.

Although great strides have been made in the area of mobility aids for the visually impaired, considerable shortcomings remain in helping them freely navigate through society. A portable device is needed to assist visually impaired individuals in assessing their environment and navigating without interference.

### BRIEF SUMMARY OF THE INVENTION

It is an object of the present application to provide an electronic assistive assembly specifically to help the visually impaired navigate and function in society. The assembly works together through its components to provide at least three layers of insight, namely a navigation layer, a spatial awareness layer, and a computer vision layer. These layers are designed to provide enhanced route guidance, awareness of the environment and surroundings, and the capacity to search and scan the immediate environment to identify objects. Each of these layers are incorporated into a generated immersive 3D audio output to the user.

It is a further object of the present application that the system be functional with existing assistive mobility aids and be low impact on the user. Through the assembly of components, feedback is delivered to the user through immersive 3D audio to provide functional mental maps of the surroundings.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a chart of a smart cane assembly according to an embodiment of the present application.

FIG. 2 is a chart showing representative meanings for various icons used in FIG. 1.

FIG. 3 is a schematic of an exemplary electronic device used within the smart cane assembly of FIG. 1.

FIG. 4 is a side view of a cane in the smart cane assembly of FIG. 1.

FIG. 5 is a perspective view of the cane of FIG. 4 coupled to a legacy mobility aid.

FIG. 6 is a side view of a headset used in the smart cane assembly of FIG. 1.

FIG. 7 is a chart of subsystems and basic purposes within the smart cane assembly of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring specifically to the assembly of the present application, one or more of the above-discussed problems commonly associated with the prior art discussed previously are overcome. In particular, the smart cane assembly is a mobility enhancement system wherein an electronic assistive device is designed specifically for people who are blind and visually impaired (BVI). The system comprises multiple interconnected components that work together to provide at least three layers of environmental insight: Navigation Layer, Spatial Awareness Layer, and Computer Vision Layer.

Core functional principles and features of the present assembly include immersive 3D audio synthesis and spatial positioning wherein the assembly creates comprehensive audio augmented reality environments for the user. The assembly also provides obstacle avoidance technology with 360-degree awareness including real-time detection independent of user orientation. Continuous monitoring of the environment allows for the creation of an audio-augmented reality environment that transforms physical spaces into navigable audio landscapes for the user to “see”. The assembly incorporates head-tracking based line-of-sight detection configured to provide peripheral awareness beyond traditional “white cane” coverage. The assembly uses a multi-sensor data fusion for environmental mapping incorporating an integration of laser, visual, and inertial data. Furthermore, the assembly generates real-time audio marker and beacon generation systems (i.e. use of waypoints) to create a dynamic spatial audio guidance function. These and other unique features are discussed below and illustrated in the accompanying drawings.

The assembly is primarily designed to be used alongside traditional mobility aids, such as the “white cane”. The assembly uses a mobile handheld scan tool, or electronic cane, that is able to integrate with traditional mobility aids by selectively docking onto “white canes”, thereby enhancing rather than replacing established navigation methods. The electronic cane is given a handheld form factor to be swung by the user in one hand either with or without the white cane. Use of the electronic cane allows a user to selectively perform search and scan functions in the immediate environment to identify objects and ascertain specific distances.

Smart electronic devices, such as cellular smartphones, are used to process location data and orientation data to assist in the development of the 3D audio environment. All feedback is delivered through immersive 3D audio that makes sounds appear to originate from their actual physical locations, allowing users to build mental maps of their surroundings while maintaining full control over what information they receive.

These features are combined with enhanced navigation route guidance using waypoints to seamlessly direct the user where to go by breaking up the total navigation into specific smaller routes. Additionally, the waypoints are inserted into the immersive 3D audio environment. The sound level within the environment can be enhanced or minimized in different ways, including in response to line of sight.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

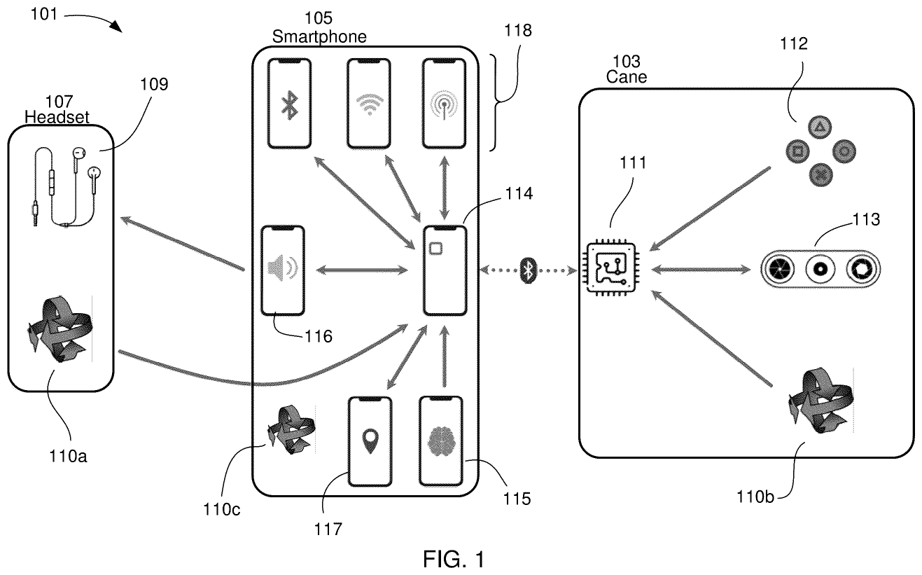

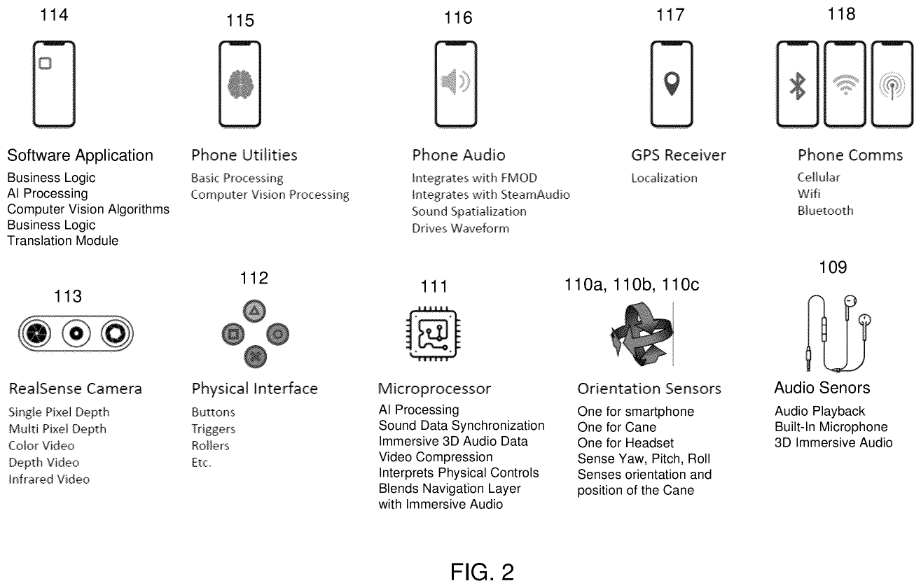

Referring now to FIGS. 1 and 2 in the drawings, smart cane assembly 101 is illustrated. The assembly of the present application is configured to be held by a visually impaired user in a single hand. The assembly 101 is configured to emit one or more beams to detect objects in the environment and present that data to the user via an audible sound. Assembly 101 includes a cane 103, a smartphone 105, and a headset 107. Each part is configured to communicate with the other through known wired and/or wireless communications. Data may be transmitted between them in real time to provide accurate and meaningful information to the user. In general, cane 103 includes one or more sensors to detect obstacles in the environment, phone 105 processes the information, and headset 107 conveys the information to the user.

Referring now also to FIG. 3 in the drawings, a schematic of a representative electronic device used within assembly 101 is provided. The functions and features of assembly 101 are such that one or more electronic devices and systems operate in a cooperative manner to produce the various features and functions described herein. Any of the electronic components or devices in assembly 101, herein referred to may include a computing system of some type. FIGS. 1 and 2 illustrate an exemplary set of components/devices used to facilitate the features and functions of assembly 101.

The computing system 10 includes an input/output (I/O) interface 12, a processor 14, a database 16, and a maintenance interface 18. Alternative embodiments can combine or distribute the input/output (I/O) interface 12, processor 14, database 16, and maintenance interface 18 as desired. Embodiments of the computing system 10 can include one or more computers that include one or more processors and memories configured for performing tasks described herein below. This can include, for example, an electronic computing device (i.e. computer) having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations and cell phones, that are suitable for also performing other tasks. Furthermore, the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the computing system 10. The I/O interface 12 can be configured for allowing one or more users to input information to the computing system 10 via any known input device. Examples can include a keyboard, mouse, touch screen, microphone, and/or any other desired input device. The I/O interface 12 can be configured for allowing one or more users to receive information output from the computing system 10 via any known output device. Examples can include a display monitor, a printer, a speaker, and/or any other desired output device. The I/O interface 12 can be configured for allowing other systems to communicate with the computing system 10. For example, the I/O interface 12 can allow one or more remote computer(s) to access information, input information, and/or remotely instruct the computing system 10 to perform one or more of the tasks described herein. The I/O interface 12 can be configured for allowing communication with one or more remote data sources. For example, the I/O interface 12 can allow one or more remote data source(s) to access information, input information, and/or remotely instruct the computing system 10 to perform one or more of the tasks described herein.

The database 16 provides persistent data storage for computing system 10. While the term “database” is primarily used, a memory or other suitable data storage arrangement may provide the functionality of the database 16. In alternative embodiments, the database 16 can be integral to or separate from the computing system 10 and can operate on one or more computers. The database 16 preferably provides non-volatile data storage for any information suitable to support the operation of the computing system 10, including various types of data discussed below.

The maintenance interface 18 is configured to allow users to maintain desired operation of computing system 10. In some embodiments, the maintenance interface 18 can be configured to allow for reviewing and/or revising the data stored in the database 16 and/or performing any suitable administrative tasks commonly associated with database management. This can include, for example, updating database management software, revising security settings, linking multiple devices, and/or performing data backup operations. In some embodiments, the maintenance interface 18 can be configured to allow for maintenance of processor 14 and/or the I/O interface 12. This can include, for example, software updates and/or administrative tasks such as security management and/or adjustment of certain tolerance settings.

Processor 14 is configured to receive communication data from one or more sources, such as technologies 103 and 105, and process that data according to one or more user parameters. Examples of parameters could be limitations, warnings, time related functions, spatial restrictions such as location limitations, and so forth. Processor 14 can include various combinations of one or more computing systems, memories, and software components to accomplish these tasks and functions. The communication data from technologies 103 and 105 are synthesized and processed to generate the 3D audio output for the user to listen to. The location and assignment of each component within computing system 10 may be divided up and located within one or more of cane 103, phone 105, and headset 107.

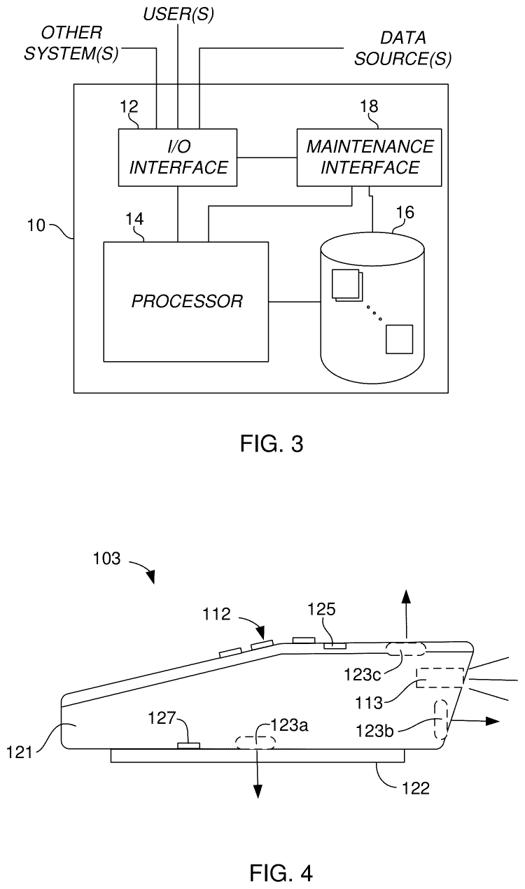

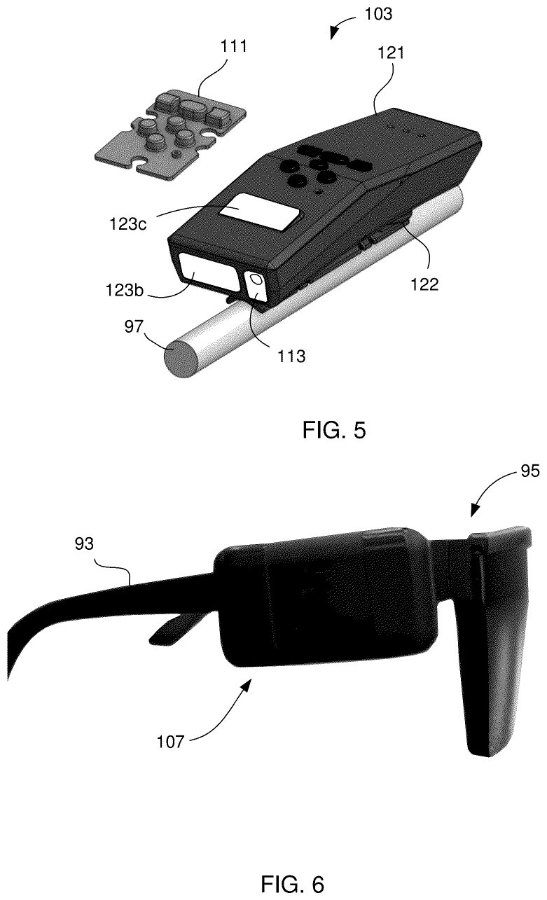

Referring now also to FIGS. 4 and 5 in the drawings, views of cane 103 are provided. Cane 103 is a handheld device that serves as the primary sensory input and user interaction point for assembly 101. Cane 103 integrates multiple sensors and control mechanisms within an ergonomic form factor designed for handheld operation or “white cane” mounting. Cane 103 functions as an intelligent environmental scanner that collects spatial, visual, and audio data for processing by the smartphone application 114. FIG. 4 illustrates an exemplary side view of cane 103 as well as locations for its functional components.

Cane 103 includes a hardened body 121 suited for handheld operations and an ergonomic feel. Along its outer surfaces are physical interface 112, camera 113, sensors (i.e. range finder capable sensors) 123a-c. Orientation sensor 110b is internal to body 121 and is not specifically depicted in FIGS. 4 and 5 for clarity, but is shown in other Figures. It is understood that the precise location of these items are not meant to be limited to the depicted locations only. Other shapes, forms and locations are possible. Body 121 is configured to be selectively coupled to the “white cane” 97 (legacy mobility aid). Body 121 can include mount 122 formed along a lower surface and configured to engage and releasably couple to white cane 97 as seen in FIG. 5.

The orientation sensor 110b, camera 113, physical interface 112, and sensors 123a-c. Each is in communication with a microprocessor 111. The orientation sensor 110b is configured to sense the orientation of the cane 103, such as the yaw, pitch, and roll (9-axis sensor configuration). Some primary functions of orientation sensors 110a-c are to give absolute orientation sensing, gesture recognition, and pointing direction determination. Sensor 110b may also be used to ascertain the elevation of the cane 103 above a surface. In general, it helps to provide coordinate information relative to the cane 103 that will be used to assist in generating the 3D audio output to the user. Sensor 110b may be used to provide more or less information relative to the orientation of the cane 103 and its location as needed and assembly 101 is not restricted to only these features with respect to sensor 110b.

Sensors 123a-c are ideally laser range finders configured to determine the distance between body 121 and an object in the environment. Sensors 123a-c are situated on different facing surfaces of cane 103 to allow assembly 101 to monitor different directions simultaneously. The direction of orientation is shown by the arrows in FIG. 4. Selected depth of range is determined by design constraints but an example of a distance for each sensor 123a-c is that of 12 meters. Its field of measurement is a single-point configuration for directed scanning. As seen in FIG. 4, three such sensors 123a-c are located to provide a forward facing, upward facing, and a downward facing range finding capability. There may be more or less sensors 123a-c. In operation, a user may gather distance data from any of them individually or from any plural combination of them.

Cane 103 can include a docking sensor 127 along a lower surface adjacent mount 122. An example of sensor 122 may be that of a hall effect sensor. When docked with white cane 97, sensor 123a is automatically deactivated. Other of sensors 123b and 123c may also be automatically deactivated at that time. A user can selectively activate or deactivate the sensors as desired at any time. Information related to sensors 123a-c are related to microprocessor 111.

Camera 113 is configured to capture video of the environment and determine depth/distance between a surface of cane 103 and an object in the environment. Camera 113 may be used to emit one or more beams/pixels into the environment to determine distance. Camera 113 may be a RGB-D Camera (Red, Green, Blue-Depth) to provide the capabilities required. Video may be captured to assist in many types of functions as will be illustrated later. Color video, depth video, and infrared video may be a function of camera 112. Information related to the environment are captured through camera 113 and passed to microprocessor 111.

Physical interface 112 is configured to be located adjacent an outer surface of cane 103 and enable the user to engage with assembly 101 so as to elicit commands, select functions, and/or modify features and preferences to name a few. Interface 112 may be seen in any form such as electronic or physical buttons, triggers, rollers, LED arrays, and so forth. Ideally a user may use interface 112 to operate assembly 101.

Microprocessor 111 receives data from each of sensor 110b, camera 113, interface 112, and sensors 123a-c in the form of distance data, visual data, orientation data, and even location data. Microprocessor 111 is configured to provide sensor control, data processing, and communication management between cane 103 and phone 105. The information is processed and configured for communication to phone 105. Data may be received and sent via microprocessor 111 wirelessly or via wired communications. Microprocessor 111 is configured to include a level of logic. It controls sensors 110b and 123a-c, processes video data from camera 113, and interprets physical inputs from user and other controls.

Cane 103 may also include microphone 125 configured to receive voice commands from the user. Additionally, cane 103 can be configured to include haptic feedback functions that can be programmable as standard feedback vibration patterns or even modifiable and customizable vibration patterns by the user.

Referring now also to FIG. 6 in the drawings, a representative side view of headset 107 is provided. Headset 107 is a head tracker device and serves as the spatial orientation reference system for assembly 101. It monitors the user's head position and orientation to enable accurate 3D audio spatialization. Orientation sensor 110a is located within headset 107 and is similar in form and function to that of orientation sensor 110b above. Accurate audio spatialization only occurs if it is produced in relation to the orientation of the user's head. Headset 107 communicates head tracking data, wirelessly or wired, to the smartphone application 114. Data captured through sensor 110a is sent to application 114 to translate and blend with the data received from microprocessor 111 and sensor 110b. This allows assembly 101 to position audio cues relative to the user's actual head orientation rather than the handheld device orientation. This decoupling of head and hand tracking enables natural exploration of the environment while maintaining spatial audio accuracy.

Headset 107 is configured to be a compact and easily carried or transported device on the head of the user. Headset 107 is configured to be located off the ears of the user as such a location would operate to potentially further block or hinder the hearing of the user, which is only more of a concern with visually impaired users. Therefore, headset 107 is configured to be located either on or within a pair of glasses. As seen in FIG. 5, headset 107 is coupled to frame 93 of glasses 95. Headset 107 is selectively detachable. Headset 107 may include a mounting mechanism configured to secure it to the head of the user. Options include various clips, bands for glasses, a clip to attach it to a hat, etc. The default option is a band to slide onto glasses. Headset 107 is compatible with various head sizes and shapes.

It is understood that in other embodiments, headset 107 may be fully incorporated within frame 93. Headset 107 includes audio sensors 109 used to engage with the ears of the user to provide accurate immersive 3D spatial audio. Audio devices 109 which may be headphones configured to play the audible sound. A microphone may be used within audio devices 109 or via device 116. Additionally, as headset 107 is detachable from the user, or able to be located onto different areas on the head, headset 107 is configured to reset or properly align its orientation to the of the head of the user as necessary, such as when initially turned on or in the case of a sudden jarring movement (i.e. knocked off).

It is noted that Headset 107 provides critical orientation data to enable the smartphone application's 114 PHASE (Physical Audio Spatialization Engine) framework to accurately position 3D audio sources relative to the user's head orientation. This creates an immersive audio environment where sounds maintain their spatial positions as the user turns their head, essential for effective navigation and environmental awareness.

Referring back to FIGS. 1 and 2 in the drawings. Phone 105 serves as the central processing hub, utilizing on-device AI processing, computer vision algorithms, and cloud-based artificial intelligence services to transform raw data into actionable spatial audio guidance. In operation, cane 103 captures environmental information around the user and sends it to phone 105. Headset 107 transmits the head orientation data to phone 105. The data between cane 103 and headset 107 must be processed and synced in real-time to generate comprehensive 3D output spatial awareness. The head orientation data enables accurate 3D output audio spatialization independent of hand position. This dual-sensor approach allows users to naturally scan their environment with the handheld device while maintaining consistent spatial audio reference relative to their head position, critical for effective navigation and environmental understanding for blind and visually impaired users.

Orientation sensor 110c within phone 105 transmits orientation data of phone 105 to smartphone application 114. The data (i.e. depth, location, orientation, movement) of objects in the environment are translated to coordinates matching the facial direction of the user's head. The sound is to be keyed to the orientation of the user's head much like our ears naturally hear with.

Phone 105 includes a communication suite 118 to permit it to communicate via a various number of wireless communication methods. This is not fully exhaustive and is therefore not intended to be limiting in any way. Phone 105 can communicate over or through one or more different types of networks.

Phone 105 includes a level of utilities 115 that are useful to assembly 101. These can relate to basic processing capabilities of phone 105 which may be used in combination with microprocessor 111 to enable the various functions and features of assembly 101. A GPS receiver 117 is provided within most phones 105 and is used to ascertain the location of the user and therefore the cane 103. This is useful with respect to navigation services for example. Assembly 101 is configured to be operated through a software application 114 on phone 105. The user is able to configure different settings and preferences through application 114 to assist with operation of assembly 101. Application 114 includes logic and a translation module to process information.

An audio device 116 is provided within phone 105 to not only provide audio output to headset 107 but may also be used to capture audible communication from the user, such as via a microphone. Data processed by microprocessor 111 and application 114 is passed through audio device 116 prior to being transmitted to headset 107.

It is an object of assembly 101 that the sound be provided to the user in a meaningful manner wherein the sound is spatialized into a 3D audible environment. It is known and understood that the features and functions of the assembly of the present application are illustrated in a particular embodiment herein to facilitate conveyance of the idea and operation. It is known that the precise components, their locations, and specific tasks may be modified and still accomplish the spirit of assembly 101.

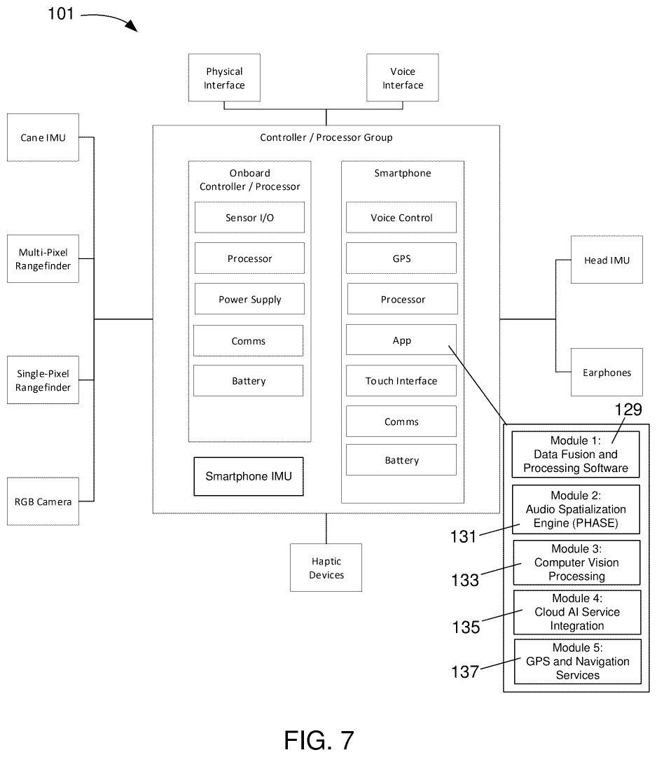

Referring now also to FIG. 7 in the drawings, a chart of the subsystems and basic purposes of the portions of assembly 101 are provided. The IMU in cane 103 is configured to measure the orientation of cane 103. The rangefinder (single-pixel or multi-pixel is configured to measures distance from the cane 103 to the nearest object along a single/array of directions from the cane. As noted previously voice commands may be captured through an interface such as a microphone. Voice commands along with other interfaces permit the user to customize, select functions and features, and receive feedback from assembly 101. For example, audible sounds may be provided, user's voice may be captured to provide commands, haptic feedback may be provided to user. Headset 107 includes an IMU much like cane 103.

FIG. 7 provides an exemplary configuration for the controller/processor group of phone 105. The different functions and capabilities have been addressed previously but are shown for additional clarity. The controller and processors of the phone 105 and cane 103 may be shared. Phone 105 and Software application 114 may include core processing modules.

Module 129 is for the Data Fusion and Processing Software. It is configured to provide real-time sensor integration from cane 103 and headset 107. The sensor data from these are synchronized and timestamped. This module helps to correlate and validate this data together.

Module 131 is for the Audio Spatialization Engine-PHASE (Physical Audio Spatialization Engine) Framework. This is used to provide a 3D spatial audio rendering based on head orientation data and handheld orientation data for the immersive audio environment generation.

Module 133 is for Computer Vision Processing. It is used to provide object detection and identification using YOLO machine learning models. It helps to provide real-time object classification and tracking. Objects seen through camera 113 can be processed and compared to other visual objects of known visual shape to help aid in identification so as to be relayed to the user. This allows a user to seek an object like a “backpack” and search for it via cane 103.

Module 135 is for Cloud AI Service Integration. This module incorporates Vision Language Models (VLM) for advanced scene description and Large Language Models (LLM) integration. Voice command processing is also included to allow audio commands captured by cane 103 as MP3 files, transmitted to phone operating systems for on-device transcription. It is noted that Cloud AI features require active internet connection; unavailable features will notify user when offline.

Module 137 is for GPS and Navigation Services. This module incorporates GPS receiver functions to provide GPS integration, namely location services for user positioning, wayfinding service for turn-by-turn navigation, and waypoint management and route calculation.

The data follows a simple real-time process to generate the 3D audio output. The sensors capture the information or data and send it to phone 105. The data is run through data fusion to combine inputs and data from multiple sensors. The coordinate system transformation occurs for spatial audio positioning. Environmental data is processed for 3D audio generation. Continuous updates of the environment occur.

In operation a user may engage an interface of assembly 101 and direct the cane 103 at a particular area within the environment. For example, the user may use cane 103 wherein a single pixel rangefinder for point depth measurement is activated. The user may toggle the assembly “on” with the hold of a button. A single beam may be sent from cane 103 into the environment to detect anything that differs from the assumed structure. A spatialized tone/sound is played at the intersecting point. The tone is enhanced by pitch such as a higher tone for shorter distances and a lower tone with longer distances for example.

More than one tone is permitted. For example, a primary tone may be played with an object within range while a secondary tone is played if the beam is not hitting anything, such as when it is pointed at the sky. One or more tones are possible depending on the circumstances. The range for the single beam can be selected upon design constraints but is potentially as far as 30-40 feet. The beam may be used to measure size of an object by moving the beam around to determine the perimeter as the sound changes tone. Likewise, the amount or volume of space in an area may be determined in much the same way.

Cane 103 may also provide a multi pixel range finder or multi-point scanner function wherein multiple beams are sent to the environment. This operates similar in form and function to that of the single pixel manner but allows the user to analyze a larger footprint in a given moment. This may occur through interaction with interface 112 or phone 105. Toggling a button and holding it depressed is one manner of activating this function. Assembly 101 is configured to assume that the environment is naturally a flat floor with no walls or objects. When there is a variation from the assumed environment. The distance to the obstruction is measured. The location data and the distance data for the object is processed and spatialized and provided to the user via an audible sound in a 3D audible environment.

The sounds may be varied depending on the condition. For example, at the onset of the object a particular sound of a set volume will be played. The sound will play for a limited duration while that object is detected. A positive sound is played when the beam is shorter than expected (sees an object). Likewise, a negative sound may be played when the beam is longer than expected (i.e. a hole). The range may be anywhere from 15-20 feet for example. It is expected that assembly 101 may be able to also distinguish between smooth and rough surfaces to help notify the user of environmental differences such as grass and concrete.

Navigation features are also possible with assembly 101 as made more feasible with the inclusion of phone 105. The user engages an interface (i.e. interface 112) to cure a navigation specific voice recognition. The user may provide a location, seek information on a location, set way points, provide instructions on modifying a route, and so forth. Waypoints may be provided by the user manually with cane 103 or via the user through an interface like voice commands. Alternatively, a list of waypoints may be provided or obtained through known navigation programs such as Google Maps. The waypoints are successive steps of a route that when completed, allow a user to reach a particular destination. The waypoints are spatialized into audio beacons which can be heard by the user. The sound level of the beacons may be automatically adjusted based upon the line of sight of the user relative to the beacon location. Positive feedback about the precise direction to the waypoint (i.e. an extra tone when the user's head or the device is pointed directly toward the waypoint)

The user then moves toward such waypoints in succession as they are made audible. Once the user gets within a set radius of each active waypoint, the tone is modulated to enrich information about the waypoint (i.e. it beeps faster the closer the user is to the waypoint). Upon reaching the waypoint, the user is presented with a positive feedback tone indicating that the waypoint has been reached. Upon completion of one waypoint, the system begins playing the beacon tone for the next waypoint.

The single point and multi point tool functions of cane 103 are still operable while waypoint navigation is operational. A user may point cane 103 at a waypoint direction and receive a positive feedback tone. The distance to a particular waypoint may also be provided upon request.

Conventional navigational features are incorporated within assembly 101. For example, automatic rerouting, manual control to vary waypoints or skip waypoints, save or customize routes and waypoint locations, and curve interpretation and presentation are possible. A user is provided full control over the routing and navigation features of assembly 101.

The use of camera 113 also permits object recognition in the environment. Video data is captured through camera 113. The shape and size of known or common objects may be stored within assembly 101. An interface of assembly 101 may be engaged and a user (i.e. voice command) may request object detection and/or recognition. The assembly uses live onboard object recognition to create spatial audio indications that play when the device is aimed at a particular type of object. Upon request, the system can take a still picture, upload the picture to an offboard photo-interpretation system, and provide a narrative of the picture to the user.

Upon request, the system can help the user look for a particular type of object. The user is notified once an object of the requested type is within the video frame of camera 113. The system uses spatialized audio cues to guide the user as he/she points the device around the environment. Tones, pitch variation, and frequency variations may be used to assist in searching the environment for the object requested. When pointed directly at the found object a particular sound may be played. The user uses proprioceptive senses to approach the requested object. For instance, a user may be looking for his/her hat. The user may command assembly 101 to find or search for the hat. Camera data is then used and compared with a list of semantic objects in a database. When detected, the spatialized sound is played.

Another feature is that the assembly 101 may be used to recognize an object. A user may ask for assembly 101 to identify an object that cane 103 is directed on. In this process, the spatialized audio may be enhanced with pitch variations and frequency changes to represent distance from object. The search or recognition would end when the interface is used to stop the function (i.e. release the button).

It should be known that the user may use assembly 101 to store and classify objects and their semantic form in a database. For example, the user may point to an object known to them and state that it is a top hat. The user could point to another object and say it is a baseball cap. These semantic forms can be saved and used later as needed.

The semantic recognition processing may be done via phone 105. The system may handle the identification and subsequent announcement of the object differently based on the size of the object. When an object is detected and matches a semantic shape the spatialized sound may be played for a large object when the centerline of the scanner passes into the objects bounding box (defined perimeter of the object), or for a small object when the entire bounding boss is within a “spotlight” radius of the object.

The use of camera 113 also permits functions such as “picture taking” wherein a picture may be taken of the environment. Camera 113 may be used to capture other environmental cues and features, such as read a bar code, identify and count money, read wording, convey a scene narrative of the environment (i.e. two people sitting in a park bench), identify color. The option to query the environment is possible. Such identification may be provided in a known language to the user as opposed to a single noise.

Particular technological advantages and differentiators are as follows: 1) Immersive 3D Audio Environment: Creates comprehensive spatial audio representation vs. simple audio warnings; 2) Multi-Sensor Fusion: Combines laser ranging, computer vision, IMU, and GPS vs. single-sensor approaches; 3) AI-Powered Object Recognition: Real-time semantic object identification vs. basic proximity detection; 4) Head-Independent Detection: Patented peripheral awareness technology; and 5) Cloud AI Integration: Advanced scene understanding via Vision Language Models

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A smart cane assembly, comprising:
a cane including an electronic processing device and a first orientation sensor configured to sense the orientation of the body, the cane including a user interface;
a sensor located within the cane configured to detect objects within an environment;
a camera within the cane and configured to capture video of its environment and determine depth and distance between objects in the environment at the body, the camera configured to use single and multi pixel depth with color video, depth video and infrared video;
a phone configured to communicate with the electronic processing device to receive the orientation of the cane from the processing device;
a headset in communication with the cane and the phone, the headset configured to emit a sound when the sensor detects an object in an environment; and
a second orientation sensor located within the headset and configured to sense the orientation of the headset, the second orientation sensor configured to transmit the orientation of the headset to the phone; and
a third orientation sensor in communication with the phone;
wherein the phone is configured to translate and blend the orientation data from both the first orientation sensor, the second orientation sensor and the third orientation sensor to produce location data that accounts for both location and orientation of the object relative to the headset such that the headset receives a 3D audio output file to play as the sound, the sound being representative of the location, orientation, and distance the headset is from detected objects within an environment.

2. The assembly of claim 1, wherein the sound is spatially located for a user in the headset.

3. The assembly of claim 1, wherein the processing device is remote from the body.

4. The assembly of claim 1, wherein the electronic device is configured to include a microphone to capture audible communication from a user.

5. A smart cane assembly, comprising:
a cane having a body and including an electronic processing device and a first orientation sensor, the first orientation sensor configured to sense the orientation of the body, the cane configured to detect objects in an environment, the cane configured to produce orientation data related to the objects detected;
a headset having a second orientation sensor and is configured to sense the orientation of the headset, the second orientation sensor configured to transmit the orientation data of the headset, the headset configured to emit a sound; and
a smartphone configured to receive orientation data from the cane and orientation data from the headset, the phone is configured to translate and blend the orientation data from both the first orientation sensor, the second orientation sensor and the third orientation sensor to produce location data that accounts for both location and orientation of the object relative to the headset such that the headset receives a 3D audio output file to generate an immersive 3D audio environment to play as the sound, the sound being representative of the location, orientation, and distance the headset is from detected objects within an environment.

6. The assembly of claim 5, wherein the sensor is a range finder.

7. The assembly of claim 5, further comprising:
a secondary sensor within the cane, the secondary sensor configured to face a direction different from the sensor.

8. The assembly of claim 5, wherein the range finder is selectively and automatically deactivated.

9. The assembly of claim 5, wherein the cane includes a mount configured to couple it to a mobility aid device.

10. The assembly of claim 5, wherein the cane is configured to accept voice commands to perform different functions.

11. The assembly of claim 10, wherein the cane is configured to search or scan the environment for a particular object.

12. The assembly of claim 5, wherein the cane is configured to capture visual data from the environment and process that visual data to identify and classify objects in the environment.

13. The assembly of claim 5, further comprising:
a camera within the cane and configured to capture video of its environment and determine depth and distance between objects in the environment at the body, the camera configured to use single and multi pixel depth with color video, depth video and infrared video.

14. The assembly of claim 5, wherein the headset is coupled to eyeglasses.

15. The assembly of claim 5, wherein the headset is incorporated into eyeglasses.

16. The assembly of claim 5, wherein the phone is configured to provide navigation incorporated within the immersive 3D audio environment.

17. The assembly of claim 5, wherein the sound is spatially located for a user in the headset.

18. The assembly of claim 5, wherein the phone includes an electronic processing device configured to generate a 3D audio output in the headset representative of objects within the environment.

19. The assembly of claim 5, wherein the cane is configured to include a microphone to capture audible communication from a user.
